(19) United States
(12) Patent Application Publication
(10) Pub. No.: US 2018/0125298 A1
(43) Pub. Date: May 10, 2018

(54) SKILLET

(71) Applicant: Barebones Systems, LLC, Salt Lake City, UT (US)

(72) Inventors: Robert Emmett Workman, Morgan, UT (US); Henry Howell, Herriman, UT (US); Kristin Mecham, Springville, UT (US); Michelle Ann Merrill, Draper, UT (US); David Jared Burton, Payson, UT (US); Erik Robert Workman, Salt Lake City, UT (US)

(21) Appl. No.: 15/667,592

(22) Filed: Aug. 2, 2017

Related U.S. Application Data
(60) Provisional application No. 62/370,190, filed on Aug. 2, 2016.

(51) Int. Cl. A47J 37/10; A47J 45/06

(52) U.S. Cl. CPC A47J 37/10; A47J 45/061

(57) ABSTRACT

A cast iron skillet comprises a pan portion having a generally planar base portion and an upwardly extending and outwardly tapered wall portion integrally formed with the base portion. A handle has a base portion attached to an outer surface of the wall portion, an upwardly extending portion extending at an upward obtuse angle relative to a top edge of the wall portion, and a grasping portion depending from the upwardly extending portion and away from the pan portion, the grasping portion extending in a plane that is substantially parallel to the top edge of the wall portion.

### CROSS-REFERENCE TO RELATED APPLICATION

The present application claims priority to U.S. Provisional Patent Application Ser. No. 62/370,190 filed on Aug. 2, 2016, the entirety of which is incorporated by this reference.

### BACKGROUND

### Field of the Invention

The present invention relates generally to cookware and more specifically to skillets, frying pans and the like.

### State of the Related Art

Cast iron skillets and frying pans have been available for decades. Such skillets are typically formed from pig iron, recycled cast iron and/or scrap steel that is melted into molten cast iron. Vermiculite is often added as a bonding agent to remove impurities. The molten cast iron is then poured into a sand mold. Once sufficiently cooled, the cookware is shaken and tumbled to remove the sand mold and then shot blasted to remove any remaining sand particles. The cookware is then ground, polished, rinsed and dried. Oil is then applied to the cookware and the cookware is placed in an oven to season the cookware giving it its black color and inhibiting rust. Such prior art cookware and specifically skillets typically have a relative short handle on one side and an enclosed handle on the other side. There exists a need in the art, however, to provide a cast iron skillet that includes a handle that is longer, positioned higher above the top edge of the pan portion of the skillet and helps to dissipate heat from the handle.

### SUMMARY OF THE INVENTION

Accordingly, the present invention provides an improved cast iron skillet that includes a pan portion and a handle portion integrally formed therewith. The handle portion has a first portion angled upwardly and away from the top edge of the pan portion of the skillet and a second grasping portion that is generally parallel to the top edge of the pan portion configured for grasping by an entire hand of a user. The length of the grasping portion allows the user to better handle the weight of a cast iron skillet with a single hand without having to also grasp the opposite handle on the skillet. In addition, the length and configuration of the handle helps to keep the handle cool when the skillet is placed over a heat source, such as a stove top, open flame or charcoal briquettes.

In one embodiment, a cast iron skillet according to the present invention comprises a pan portion comprising a generally planar base portion and an upwardly extending and outwardly frustoconical wall portion integrally formed with the base portion. The base portion defines a top edge of the pan. A handle comprises a base portion attached to and extending from an outer surface of the wall portion, an upwardly extending portion extending at an upward angle relative to the top edge and a grasping portion depending from the upwardly extending portion and away from the pan portion. The grasping portion extends in a plane that is substantially parallel to the top edge of the wall portion.

In another aspect of the invention, the wall portion extends at an angle of about 70 degrees relative to the planar base portion.

In yet another aspect of the invention, the handle is integrally formed with the wall portion at an outer surface thereof.

In another embodiment, the handle comprises a gradually narrowing neck portion that connects a base portion of the handle, which is connected to the wall portion, to a grasping portion that is wider than the neck portion.

In still another embodiment, an overall length of the handle from where it attaches to the wall portion to a proximal end of the handle is greater than the effective radius of the pan portion.

In yet another embodiment, a length of the grasping portion from to the proximal end is at least 3.5 inches.

In still another embodiment, the grasping portion defines an oblong shaped recess that extends along a top surface of the handle and surrounds an oblong or teardrop shaped aperture. The oblong shaped recess provides a pressure relief surface upon which the user can place a palm of a hand to better distribute the weight of the pan portion and any food contained therein.

In still another embodiment of the cast iron skillet of present invention, a crescent shaped handle is attached proximate a top edge of the wall portion opposite the first handle.

In yet another embodiment, the crescent shaped handle comprises a handle portion that defines a crescent shaped opening for grasping by a user.

In another embodiment, a length of the handle portion is about one half of a diameter of the pan portion.

In another embodiment, the wall portion comprises a pair of spouts, each positioned on opposite sides of the pan portion. The spouts are radially disposed between the first handle and the crescent shaped handle approximately midway between.

In yet another embodiment of a cast iron skillet of the present invention, the crescent shaped handle includes a pair of base portions integrally formed with the wall portion. The pair of base portions are outwardly flared to add structural integrity and to provide a stress relief to the interface between the crescent shaped handle and the wall portion.

In yet another embodiment, the neck portion is upwardly angled relative to a plane defined by the top edge of the pan portion at an angle of between about 20 and 30 degrees.

In another embodiment, the neck portion has a length of almost half a total length of the first handle.

In yet another embodiment of the present invention, a bottom surface of the grasping portion is outwardly rounded and includes a thickened portion for ergonomic grasping by the hand of a user while the top surface provides a concave surface via the recess.

These and other aspects of the present invention may be realized in an improved skillet as shown and described in the following figures and related description.

### BRIEF DESCRIPTION OF THE DRAWINGS

When considered in connection with the following illustrative figures, a more complete understanding of the present invention may be derived by referring to the detailed description. In the figures, like reference numbers refer to like elements or acts throughout the figures. Various embodiments of the present invention are shown and described in reference to the numbered drawings.

FIG. 1 is a perspective top side view of a skillet in accordance with the principles of the present invention;

FIG. 2 is a top view of the skillet shown in FIG. 1;

FIG. 3 is a bottom side view of the skillet shown in FIG. 1;

FIG. 4 is a right side view of the skillet shown in FIG. 1;

FIG. 5 is a perspective cross-sectional side view of the skillet shown in FIG. 1;

FIG. 6 is an front side view of the skillet shown in FIG. 1; and

FIG. 7 is a back side view of the skillet shown in FIG. 1.

It will be appreciated that the drawings are illustrative and not limiting of the scope of the invention, which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention. Elements and acts in the figures are illustrated for simplicity and have not necessarily been rendered according to any particular sequence or embodiment.

### DETAILED DESCRIPTION OF THE ILLUSTRATED EMBODIMENTS

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims. Unless specifically noted, it is intended that the words and phrases in the specification and the claims be given their plain, ordinary, and accustomed meaning to those of ordinary skill in the applicable arts. It is noted that the inventor can be his own lexicographer. The inventor expressly elects, as his own lexicographer, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventor's intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors fully informed of the standards and application of the special provisions of 35 U.S.C. § 112, ¶6. Thus, the use of the words “function,” “means” or “step” in the Detailed Description of the Invention or claims is not intended to somehow indicate a desire to invoke the special provisions of 35 U.S.C. § 112, ¶6, to define the invention. To the contrary, if the provisions of 35 U.S.C. § 112, ¶6 are sought to be invoked to define the inventions, the claims will specifically and expressly state the exact phrases “means for” or “step for” and the specific function (e.g., “means for filtering”), without also reciting in such phrases any structure, material or act in support of the function. Thus, even when the claims recite a “means for . . . ” or “step for . . . ” if the claims also recite any structure, material or acts in support of that means or step, or that perform the recited function, then it is the clear intention of the inventor not to invoke the provisions of 35 U.S.C. § 112, ¶6. Moreover, even if the provisions of 35 U.S.C. § 112, ¶6 are invoked to define the claimed inventions, it is intended that the inventions not be limited only to the specific structure, material or acts that are described in the illustrated embodiments, but in addition, include any and all structures, materials or acts that perform the claimed function as described in alternative embodiments or forms of the invention, or that are well known present or later-developed, equivalent structures, material or acts for performing the claimed function.

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. Thus, the full scope of the inventions is not limited to the examples that are described below.

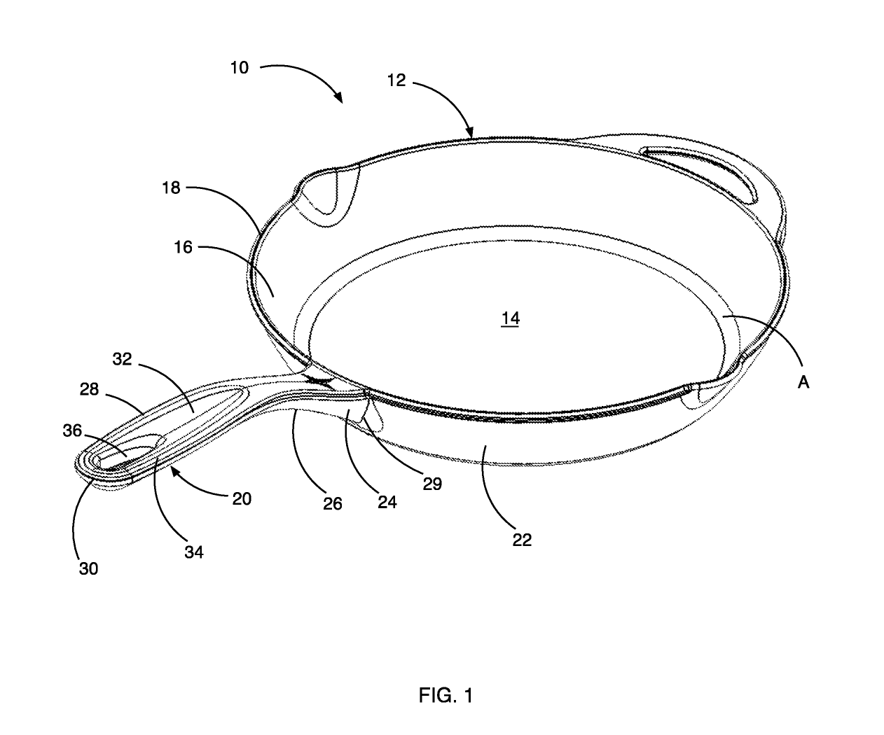

FIG. 1 illustrates a skillet, generally indicated at 10, in accordance with the principles of the present invention. The skillet 10 includes a pan portion 12 comprised of a generally planar and generally circular bottom portion 14 and an outwardly tapered and generally circular side wall 16 depending from an outer circumferential perimeter area A of the bottom portion 14. That is, the side wall 16 is generally frustoconical in shape, although it may have a slight curvature from top to bottom, and depends from the bottom portion 14 at an angle of about 70 degrees, plus or minus about 10 degrees. The skillet may come in various sizes, which are typically measured by the diameter of the top edge 18 of the side wall 16 of the skillet 10, such as for example, and not by way of limitation, 16 inches, 14 inches, 10 inches or 8 inches.

A handle 20 is integrally formed with the side wall 16 along an outer surface 22 thereof. The handle 20 has a base portion 24 that is attached to or integrally formed with the side wall 16. That is, it is most common for the handles of cast iron skillets to be integrally formed with the pan portion during the casting process, but the present invention contemplates a separately attached handle having a configuration as shown and described herein that may be attached to a cast iron pan portion by various means known in the art such as by various fasteners, such as rivets or screws, or by welding.

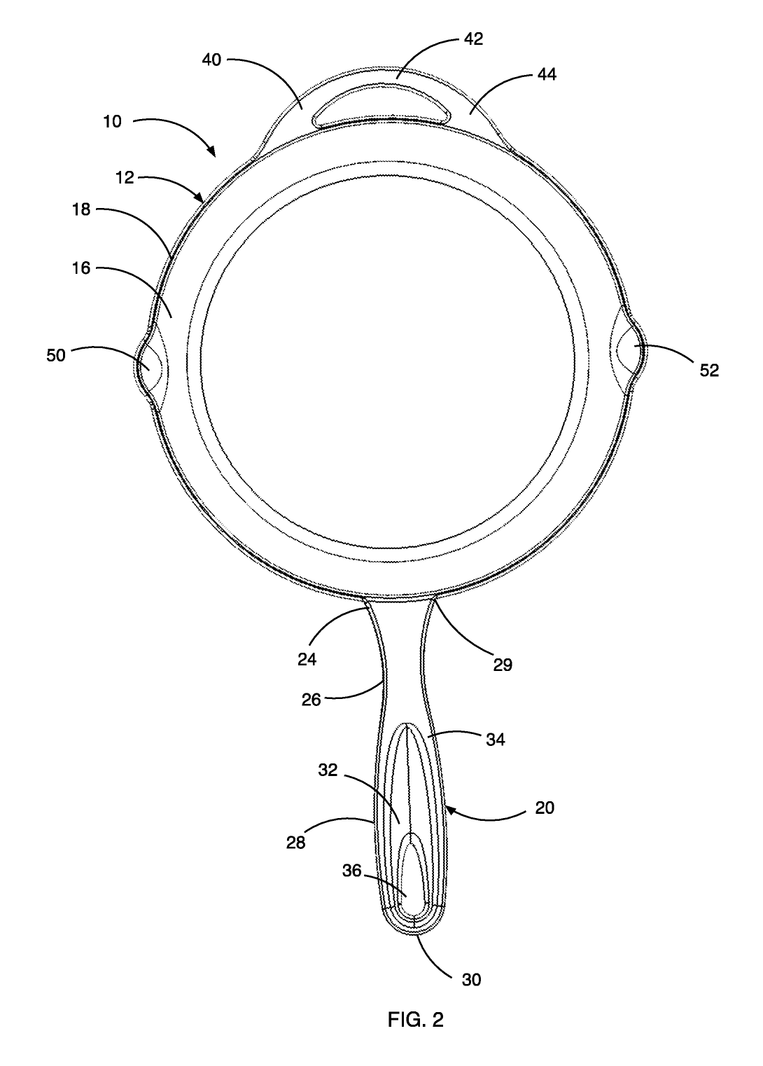

As shown in FIGS. 1 and 2, a gradually narrowing neck portion 26 of the handle 20 connects the base portion 24 of the handle, which is connected to the pan portion 12, to a grasping portion 28. The overall length of the handle 20 from where it attaches at the interface 29 to the pan portion 12 to the proximal end 30 of the handle 20 is greater than the effective radius of the pan portion 12. That is, the total length of the handle 20 is at least as long as half the effective diameter of the pan portion 12 as defined by the top edge 18. In addition, the length of the grasping portion 20 from where the neck portion 26 widens back out to the proximal end 30 is at least as wide as the width of a human hand, which may be between about 3.5 and 4.5 inches or more. The length of the handle 20 and the position of the grasping portion 28 above and away from the pan portion 12 is more ergonomically advantageous than prior art cast iron skillet handles and places less stress on the wrist of a user, especially given the weight of cast iron cookware in addition to the total weight when the skillet 10 contains food, which can double the weight of the pan portion 12.

In order to further provide a comfortable handle 20 for grasping, the grasping portion 28 defines an oblong or teardrop shaped recess 32 that extends along the top surface 34 of the handle 20 and surrounds an oblong or teardrop shaped aperture 36 that can be used to hang the skillet 10. The oblong recess 32 provides a pressure relief surface upon which the user can place the palm of a hand to better distribute the weight of the pan portion 12 and any food contained therein.

An oppositely disposed crescent shaped handle 40 is attached proximate the top edge 18 of the wall portion 16 opposite the handle 20. The handle 40 is defined by a crescent-shaped handle portion 42 that defines a crescent-shaped opening 44 so that a user can easily grasp the handle portion 42 as with his or her fingers. Thus, the user can grasp the long handle 20 with one hand and the crescent-shaped handle 40 with the other to lift the skillet 10. The length of the handle portion 42 is about one half of the diameter of the pan portion 12. Grasping of the long handle 20 with one hand and the crescent-shaped handle 40 with the other is especially useful when attempting to pour liquid from the pan portion 12 through either of the two liquid spouts 50 and 52 positioned in opposite sides of the pan portion 12. The spouts 50 and 52 are radially disposed between the handles 20 and 40, approximately 90 degrees from either handle 20 and 40. By providing two spouts 50 and 52, liquid can be more easily poured from either side of the skillet 10.

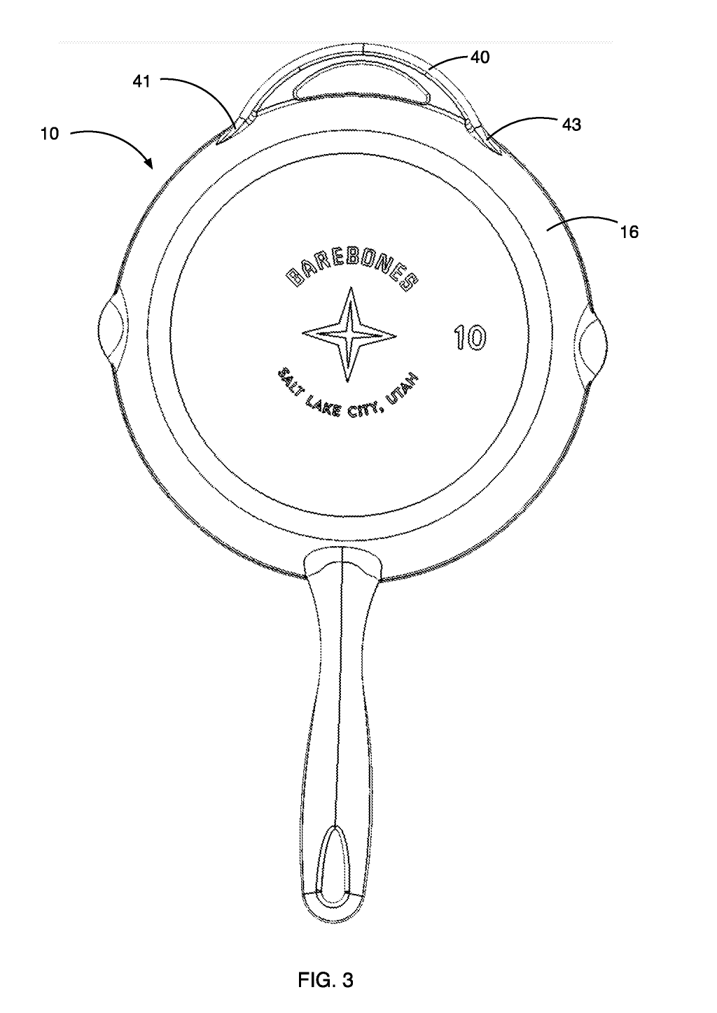

As shown in FIG. 3, which shows a bottom of the pan 10, the handle 40 includes base portions 41 and 43 integrally formed with the wall portion 16. These base portions 41 and 43 are outwardly flared to add structural integrity and to provide a stress relief to the interface between the handle 40 and the wall portion 16 so as to prevent cracking between the handle 40 and the wall portion 16 due to stress or impact that could otherwise damage the skillet 10. This is particularly important with cast iron cookware as cast iron is relatively brittle and can be damaged by cracking when dropped.

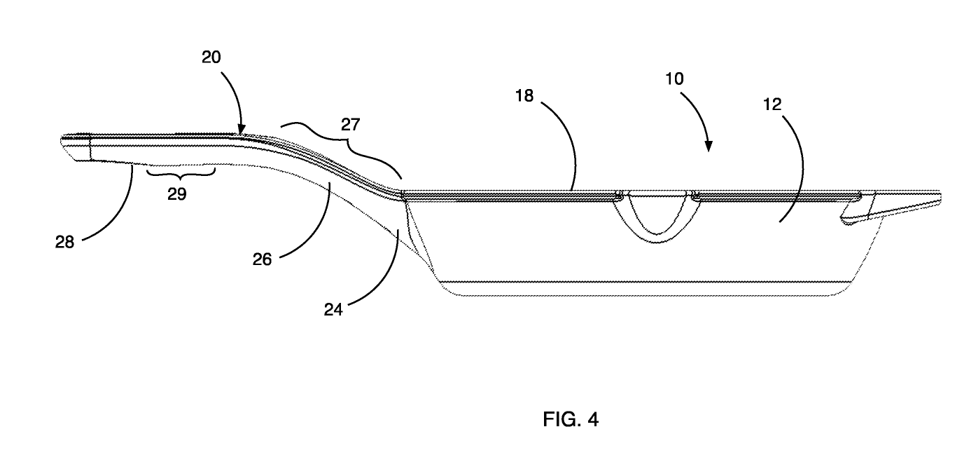

As shown in FIG. 4, the base portion 24 and neck portion 26 are upwardly angled relative to a plane defined by the top edge 18 of the pan portion 12 at an angle of between about 20 and 30 degrees. This upwardly extending portion 27 has a length of almost half the total length of the handle 20. Because of its length and upwardly extending angle, heat from the pan portion 12 and any heat source upon which the skillet 10 is placed is less likely to raise the temperature of the grasping portion 28 of the handle 20 and further allows for more convection cooling of the handle 20 while being less affected by heat from the heat source. As such, the skillet 10 of the present invention is safer to handle than prior art skillets. It is noted in this view that the bottom surface of the grasping portion 28 is outwardly rounded and includes a thickened portion 29 for ergonomic grasping by the hand of a user while the top surface provides a concave surface via the recess 32 as previously described with reference to FIG. 2.

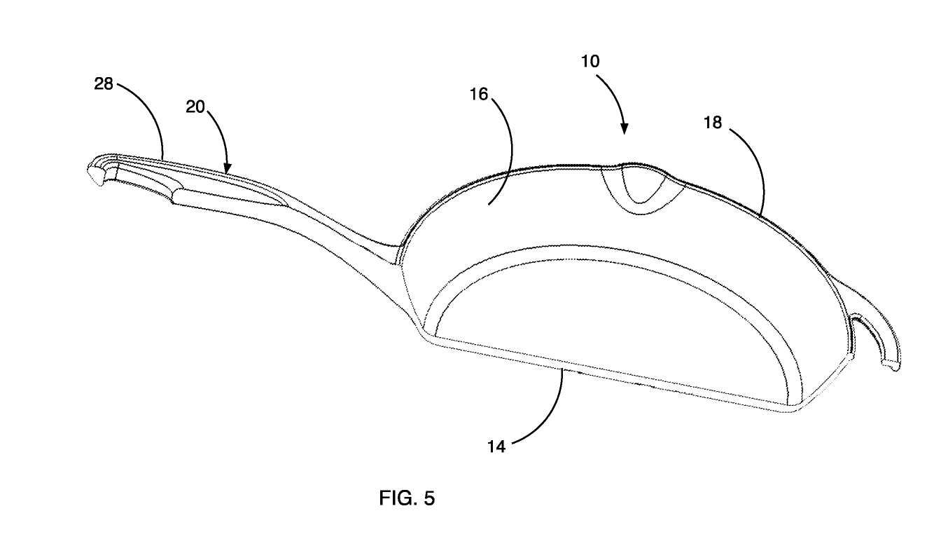

FIG. 5 shows the skillet 10 in longitudinal cross-section. The base portion 14 is comprised of a generally planar and circular plate to provide uniform heating of the base portion 14 during cooking with uniform thickness wall portion 16 integrally formed therewith. The top edge 18 of the wall portion 16 has a slightly larger thickness to form a top lip. This provides structural strength to the top edge 18 of the skillet 10 in the event that the skillet is dropped on its top edge 18. The handle 20 is thicker where it is integrally formed with the wall portion 16 and gradually tapers in thickness to the grasping portion 28.

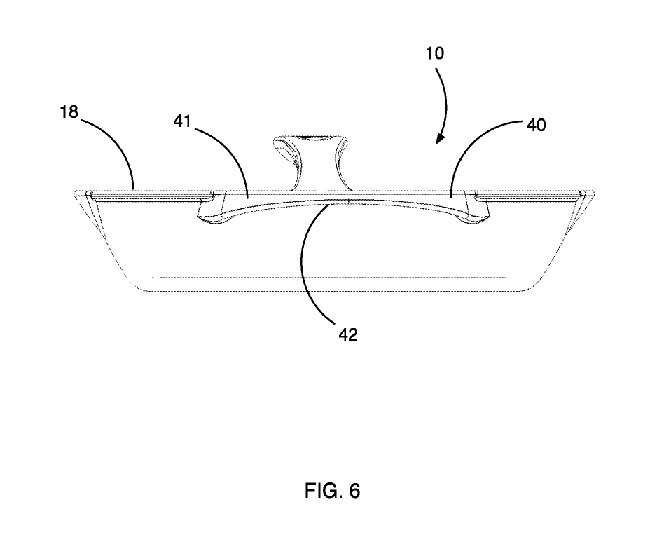

Unlike the handle 20, as shown in FIG. 6, the handle 40 of the skillet 10 is slightly curved in a downward direction and spans about half of the total width of the skillet 10 to provide a better handle portion 42 for grasping by a user. As further shown in FIG. 6, the top surface 41 of the handle 40 extends parallel to and below a plane defined by a top surface of the top rim 18 of the skillet 10. Conversely, the entire top surface of the handle 20 extends above the plane defined by the top surface of the skillet 10. Providing the handle 40 at or below the plane defined by the top rim 18 allows for easy removal of a lid and for ease of stacking with other skillets.

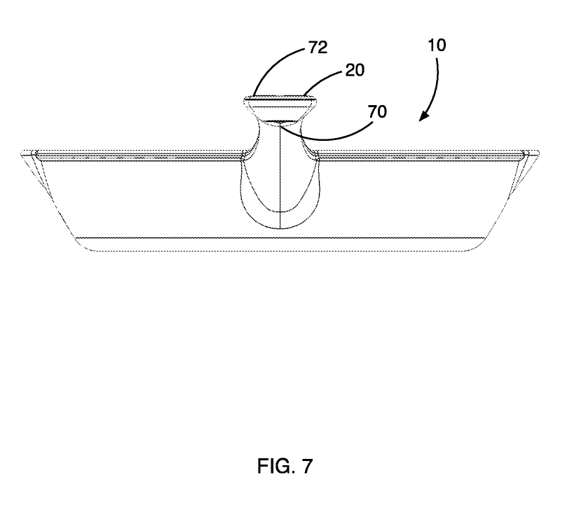

As shown in FIG. 7, the handle 20, and more specifically the grasping portion 28, has a curved bottom 70 for wrapping with the fingers of the user and a flattened top 72 for placement of the palm of the hand of the user to provide a more ergonomic handle to support the weight of the skillet 10 with the palm and arm of the user rather than the fingers of the user as is the case with prior art cast iron skillets. Such a handle configuration provides for more balanced gripping and ease of lifting the skillet with a single hand as compared to prior art cast iron skillets.

There is thus disclosed an improved skillet and method of using the improved skillet. In the foregoing specification, the present invention has been described with reference to specific exemplary embodiments. Various modifications and changes may be made, however, without departing from the spirit and scope of the present invention as set forth in the claims, including combinations of elements of the various illustrated embodiments. The specification and figures are illustrative, not restrictive, and modifications are intended to be included within the scope of the present invention. Accordingly, the scope of the present invention should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages, and solutions to problems have been described above with regard to particular embodiments. Any benefit, advantage, solution to problem, or any element that may cause any particular benefit, advantage, or solution to occur or to become more pronounced are not to be construed as critical, required, or essential features or components of any or all the claims.

The phrase “consisting essentially of” as used herein is intended to cover additional elements or functions that do not materially affect the basic and novel characteristics of the claimed invention. Thus, “consisting essentially of” is intended to encompass not only those components specifically listed, but also separate or additional components that do not materially alter the specifically recited functions or elements.

The terms “comprise”, “comprises”, “comprising”, “having”, “including”, “includes” or any variations of such terms, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials, or components used in the practice of the present invention, in addition to those not specifically recited, may be varied or otherwise particularly adapted to specific environments, manufacturing specifications, design parameters, or other operating requirements without departing from the general principles of the same.

What is claimed is:

1. A cast iron skillet, comprising:
a pan portion comprising:
a generally planar base portion; and
an upwardly extending and outwardly frustoconical wall portion integrally formed with the base portion, the base portion defining a top edge; and
a first handle comprising:
a base portion attached to and extending from an outer surface of the wall portion;
an upwardly extending portion extending at an upward angle relative to the top edge; and
a grasping portion depending from the upwardly extending portion and away from the pan portion, the grasping portion extending in a plane that is substantially parallel to the top edge of the wall portion.

2. The cast iron skillet of claim 1, wherein the wall portion extends at an angle of about 70 degrees relative to the planar base portion.

3. The cast iron skillet of claim 1, wherein the handle is integrally formed with the wall portion at an outer surface thereof.

4. The cast iron skillet of claim 1, wherein the handle comprises a gradually narrowing neck portion that connects a base portion of the handle, which is connected to the wall portion, to a grasping portion that is wider than the neck portion.

5. The cast iron skillet of claim 4, wherein an overall length of the handle from where it attaches to the wall portion to a proximal end of the handle is greater than the effective radius of the pan portion.

6. The cast iron skillet of claim 5, wherein a length of the grasping portion from to the proximal end is at least 3.5 inches.

7. The cast iron skillet of claim 4, wherein the grasping portion defines an oblong shaped recess that extends along a top surface of the handle and surrounds an oblong or teardrop shaped aperture, wherein the oblong shaped recess provides a pressure relief surface upon which the user can place a palm of a hand to better distribute the weight of the pan portion and any food contained therein.

8. The cast iron skillet of claim 1, further comprising a crescent shaped handle attached proximate a top edge of the wall portion opposite the first handle.

9. The cast iron skillet of claim 8, wherein the crescent shaped handle comprises a handle portion that defines a crescent shaped opening for grasping by a user.

10. The cast iron skillet of claim 9, wherein a length of the handle portion is about one half of a diameter of the pan portion.

11. The cast iron skillet of claim 1, wherein the wall portion comprises a pair of spouts, each positioned on opposite sides of the pan portion, the spouts being radially disposed between the first handle and the crescent shaped handle approximately midway between.

12. The cast iron skillet of claim 10, wherein the crescent shaped handle includes a pair of base portions integrally formed with the wall portion, the pair of base portions outwardly flared to add structural integrity and to provide a stress relief to the interface between the crescent shaped handle and the wall portion.

13. The cast iron skillet of claim 4, wherein the neck portion is upwardly angled relative to a plane defined by the top edge of the pan portion at an angle of between about 20 and 30 degrees.

14. The cast iron skillet of claim 4, wherein the neck portion has a length of almost half a total length of the first handle.

15. The cast iron skillet of claim 10, wherein a bottom surface of the grasping portion is outwardly rounded and includes a thickened portion for ergonomic grasping by the hand of a user while the top surface provides a concave surface via the recess.
